(19) United States
(12) Patent Application Publication
(10) Pub. No.: US 2004/0158586 A1
(43) Pub. Date: Aug. 12, 2004

(54) METHOD AND SYSTEM OF USING SHARED FILE FOR DATA COLLABORATION

(76) Inventor: Mingtar Tsai, Cupertino, CA (US)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/249,419

(22) Filed: Apr. 8, 2003

Related U.S. Application Data
(60) Provisional application No. 60/446,040, filed on Feb. 10, 2003.

(51) Int. Cl. G06F 17/30

(52) U.S. Cl. 707/200

(57) ABSTRACT

A method of using at least one shared data file for data collaboration for a plurality attendees in a meeting. The method includes first determining a web server for the meeting. Local files are opened by attendees, respectively. A computer program is invoked by the attendees to send a shared file of the local files to the web server through a network with a security level. Wherein, the web server puts the shared file at a specific directory, responds an URL path, and displays the shared file to the attendees. A command is sent to the web server to handle or modify the shared file. Attendee's browser or custom program can update and display shared file in real-time.

### CROSS REFERENCE TO RELATED APPLICATIONS

This Application claims the priority benefit of provisional application serial No. 60/446,040, filed on Feb. 10, 2003.

### BACKGROUND OF INVENTION

1. Field of Invention

The invention relates to a novel method and a system of using shared file for data collaboration. More particularly, the present invention relates to a novel method and a system of using shared file for data collaboration with privacy protection during collaborative sessions through Intranet or Internet such as e-conference, e-training or e-learning.

2. Description of Related Art

During a data collaboration session, using tools currently on the market, a user shares his/her data content by using a utility program called “application sharing” (AS). AS works by automatically sending meeting host's computer image to all meeting participants. Updated images are continuously sent to all participants to reflect any changes occurred on the host's computer. This “sharing by image” operation is data intensive and does not work well with low bandwidth connections. One of the AS's inherent technological limitations is that files and directory contents are shared at the same time. If used improperly, private and company confidential information may be disclosed inadvertently. Another use of data collaboration is to allow remote meeting participant to modify and change contents of the shared data, such as a spreadsheet or word processing document. In order to achieve this, the meeting host must grant special “remote control” privilege to the remote user. Once granted, the remote user then has complete control of the host's computer or shared applications. Private and company confidential information residing on the host's computer may be at risk.

It is a critical issue to properly manage the shared file in data collaboration with confidence.

### SUMMARY OF INVENTION

The invention provides a method of using shared files for data collaboration. The present invention is directed to a system and a method to conduct real-time data collaboration through Intranet or Internet. The system or the method supports data collaboration using shared files with privacy protection. The system also includes servers, which receive and send changes of the shared file to all participants. Participants″ browser or custom program can display and update shared file in real-time.

The present invention allows meeting participants share their local data files through Intranet or Internet. The present invention supports meeting participants sharing his/her local data files with all meeting participants. The present invention supports sharing by files during data collaboration. The present invention allows any meeting participant to change or edit the shared data.

The present invention provides privacy protection by using file sharing through Intranet or Internet. The present invention does not allow remote user to take control of any meeting participant's computer. The present invention supports synchronous data collaboration of a plurality of participants in one meeting. The present invention supports encryption of shared files for security.

As embodied and broadly described herein, the invention provides a method of using at least one shared data file for data collaboration for a plurality attendees in a meeting. The method of the invention comprises first determining a web server for the meeting. Local files are opened by attendees, respectively. A computer program is invoked by the attendees to send a shared local file to the web server through a network with a selected security level. Wherein, the web server puts the shared file at a specific directory, responds an URL path, and displays the shared file to all of the attendees. A command is sent to the web server to handle, update or modify the shared file.

The invention provides another method of using at least one shared data file for data collaboration for a plurality attendees in a meeting. The method comprises determining a web server for the meeting, wherein one of the attendees serves as a meeting host, having a sole control to the web server. Local files are opened by attendees or thehost, respectively. A computer program is invoked by the attendees or host to send a shared file of the local files to the web server through a network with a selected security level. Wherein, the web server puts the shared file at a specific directory, responds an URL path, and displays the shared file on the meeting host and attendees. The meeting host solely handles or modifies the shared file by the meeting host, wherein all attendees can see a change of the shared file.

In the foregoing method, the meeting host can be changed to any one of the attendees by taking the control of the web server.

The present invention also provides a system of using at least one shared data file for data collaboration for a plurality attendees in a meeting. The system comprises a web server, a plurality local displaying devices respectively used by the attendees, for displaying any possible file, and a network. Wherein, the attendees can send a shared file to the web server through the network. Wherein, the shared file can be displayed at the local displaying devices for the attendees. Wherein, the shared file is shared by all of the attendees for handling and modifying.

In the foregoing system, an encryption is used for transferring the shared file to the web server.

A system of using at least one shared data file for data collaboration for a plurality attendees in a meeting comprises a web server, solely controlled by one of the attendees, serving as a meeting host. A plurality local displaying devices are respectively used by the attendees, for displaying any possible local file. A network is used, wherein the attendees can send the local file as a shared file to the web server through the network, wherein the shared file is displayed at the meeting host and attendees. Wherein, the shared file is shared by the meeting host for handling and modification and the attendee can see a change of the shared file.

In the foregoing system, the meeting host can be changed to any one of the attendees by taking a sole control of the web server. At this point, the new host can modify the shared file.

In order to share edits done by meeting attendees or the host, a custom program is invoked to capture command strings such as scroll up, scroll down, page up, page down, keyboard strokes and mouse movements. To control and synchronize contents of the shared file, a special program, for example, Microsoft Object Linking and Embedding (OLE), can be used.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a system diagram, schematically illustrating an endpoint 100, which sends local files to a remote web server 102 through Intranet or Internet, according to one preferred embodiment of this invention;

FIG. 2 is system diagram, schematically illustrating that all the participants see the same file through the web browser, such as Internet Explore (IE), Netscape Navigator, or any other custom programs, according to one preferred embodiment of this invention;

FIG. 3 is a process diagram, schematically illustrating a method of using the shared file in a meeting, according to one preferred embodiment of this invention; and

FIG. 4 is a process diagram, schematically illustrating a method of using the shared file in a meeting, according to one preferred embodiment of this invention.

### DETAILED DESCRIPTION

The present invention is directed to a system and a method to conduct real-time data collaboration through Intranet or Internet. The system or the method supports data collaboration using shared files with privacy protection. The system also includes servers, which send the shared file changes and updates to all participants. Participants″ browser or custom program can update and display shared file in real-time.

During data collaboration through the Intranet/Internet, a meeting host or attendee shares his/her local files, such as text file, Microsoft Word/Excel/PowerPoint files, Adobe PDF file, or any file that can be opened and displayed by web browser such as Microsoft Internet Explorer, Netscape Navigator, or any custom programs with similar browser capabilities. After the local file has been opened in the browser or custom program, the meeting host or attendee invokes a special computer program to send this local file to a pre-determined Web server. The transmission of this shared file can be encrypted with a public or proprietary encryption algorithms for security. The web server then puts the received file in a specific directory and the corresponding URL path is sent back and displayed to meeting participants″ browsers. A SSL (Secure Socket Layer) based web server can also be used for security.

At this moment, all meeting participants have and share the same file. Any participant can be a “host” by initiating this special file sharing process. Once the file has been shared, browsing of the shared contents can be shared and updated among participants by capturing and transferring specific command strings such as scroll up, scroll down, page up, page down, keyboard strokes or mouse movements. If the shared file can be edited, such as Microsoft Word and Microsoft Excel, etc. it is possible for the attendee to share his/her edits and changes, and all participants to see those edits or changes in real-time. A special program, for example, Microsoft Object Linking and Embedding (OLE), can be used to accomplish this. Another possible mode of operation is the host mode.

In the host mode, meeting host has sole control over any movements, edits or changes of the shared file. Only the host can share movements as such scrolling up, scrolling down, scrolling right, or scrolling left and keyboard strokes, with other participants in the same meeting. Other participants can see their shared file being scrolled up, scrolled down, scrolled right, or scrolled left, exactly the same as the host. If the shared file can be edited, such as Microsoft Word and Microsoft Excel, etc. it is possible for the host to share his/her edits and changes, and all participants to see those edits or changes in real-time. A special program, for example, Microsoft Object Linking and Embedding (OLE), can be used to accomplish this. The “host mode” can be released on demand by the current host. Any participant who likes to be a host can do so once the host mode has been released.

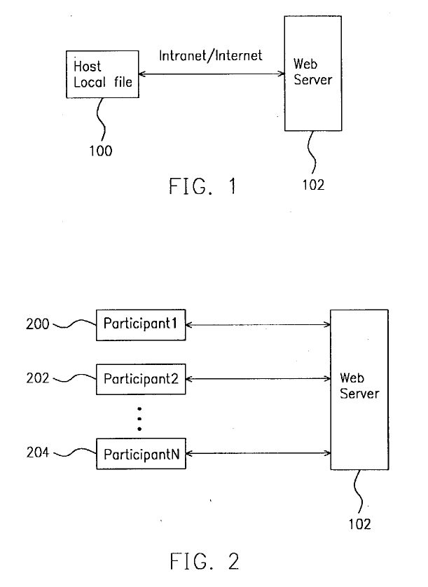

Preferred embodiment of data collaboration with privacy protection through Internet or Intranet of the present invention is illustrated in FIG. 1 and FIG. 2. FIG. 1 is a process diagram, schematically illustrating an endpoint, which sends local files to a remote web server through Intranet or Internet, according to one preferred embodiment of this invention. FIG. 2 is process diagram, schematically illustrating that all the participants see the same file through the web browser, such as Internet Explore (IE), Netscape Navigator, or any other custom programs, according to one preferred embodiment of this invention.

The foregoing features can be implemented into a system or performed as a process flow. In FIG. 1, when the meeting is held with attendees through the network, such as internet or intranet, a web server 102 is determined. After one of the attendees or host transferred the shared file to all meeting attendees through the web server 102, the host can modify the file or any operation. The attendees can see the operation of the shared file controlled or manipulated by the meeting host at the same time. This system is operated under a host mode.

The method under the host mode is shown in FIG. 4 for at least one shared data file for data collaboration for a plurality attendees in a meeting. The method comprises, step 400, determining a web server 102 for the meeting, wherein one of the attendees serves as a meeting host 100, having a sole control to the web server. In step 402, local files are opened by meeting attendees, respectively. In step 404, a computer program is invoked by the attendees to send a shared file of the local files to the web server 102 through a network with a security level. Wherein, the web server 102 puts the shared file at a specific directory, responds an URL path, and displays the shared file on the meeting host 100 and all attendees. In step 406, the meeting host 100 solely handles or modifies the shared file by the meeting host, wherein all attendees can see a change of the shared file.

The meeting host can be shifted to another attendee by for example, releasing the control of the meeting host. Then, any attendee can take control as the meeting host. This operation has better privacy protection than “Application Sharing” because edits are done at current host's local computer and does not need the special “remote control” privilege as mentioned in [002].

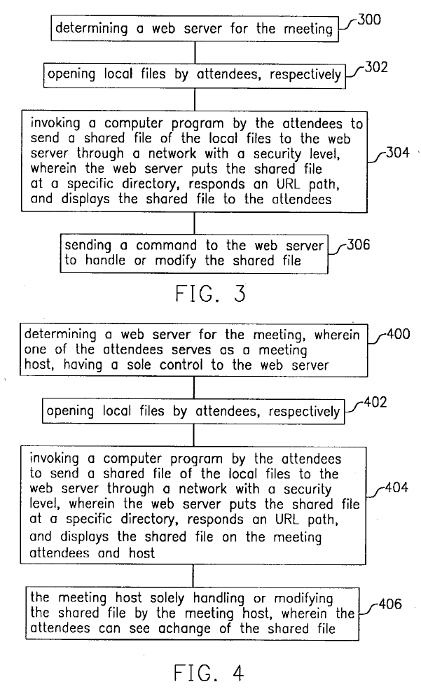

Alternatively, the system shown in FIG. 2 allows several attendees or all of the attendees to share and control the file. In FIG. 2, several attendees 200 204 can access the web server 102 to display and manipulate the shared file to the multiple attendees. In FIG. 3, the method is shown in several steps.

At least one shared data file for data collaboration for a plurality attendees 200 204 is used in a meeting. The method of the invention comprises, in step 300, first determining a web server 102 for the meeting. In step 302, local files are opened by attendees, respectively. In step 304, a computer program is invoked by the attendees to send a shared file of the local files to the web server 102 through a network with a selected security level. Wherein, the web server puts the shared file at a specific directory, responds an URL path, and displays the shared file to the attendees 202-204. In step 306, a command is sent to the web server 102 to handle or modify the shared file by any one of the meeting attendees.

In conclusions, the present invention has provided a method to use the shared file in data collaboration with high security and privacy for the attendees in a collaborative session. The system and method are described to conduct real-time data collaboration through Intranet or Internet. The system and method support data collaboration using shared files with privacy protection. The system also includes servers, which send shared file changes and updates to all participants. Participants″ browser or custom program will update and display shared file in real-time.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A method of using at least one shared data file for data collaboration for a plurality attendees in a meeting, comprising:
determining a web server for the meeting;
opening local files by attendees, respectively;
invoking a computer program by the attendees to send a shared file of the local files to the web server through a network with a security level, wherein the web server puts the shared file at a specific directory, responds an URL path, and displays the shared file to the attendees; and
sending a command to the web server to handle or modify the shared file.

2. The method of claim 1, wherein the security level is achieved by using an encryption manner.

3. The method of claim 1, wherein the method is used in collaborative sessions through the network such as in e-conference, e-training or e-learning.

4. The method of claim 1, wherein the shared file is displayed by a web browser or a custom program.

5. The method of claim 4, wherein the web browser comprises Microsoft Internet Explorer (IE), Netscape Navigator or like Web Browsers.

6. The method of claim 4, wherein the custom program has a function to perform like browsers of Microsoft Internet Explorer (IE), Netscape Navigator or like Web Browsers.

7. The method of claim 1, wherein the command comprises scroll up, scroll down, scroll right, scroll left, page up, page down, keyboard strokes or mouse movements

8. The method of claim 1, wherein the command comprises processing the share file.

9. The method of claim 1, further comprising using an Object Linking and Embedding (OLE) program to control and synchronize contents of the shared file.

10. The method of claim 1, wherein the web server using a secure socket layer (SSL) for security.

11. A method of using at least one shared data file for data collaboration for a plurality attendees in a meeting, comprising:
determining a web server for the meeting, wherein one of the attendees serves as the meeting host, having a sole control to the web server;
opening local files by attendees or meeting host, respectively;
invoking a computer program by the attendees or meeting host to send a shared file of the local files to the web server through a network with a security level, wherein the web server puts the shared file at a specific directory, responds an URL path, and displays the shared file on the meeting host and attendees; and
handling or modifying the shared file solely by the meeting host, wherein the attendees can see a change of the shared file; sending a command to the web server to handle or modify the shared file by the meeting host.

12. The method claim 11, wherein the meeting host can be changed to any one of the attendees by taking the control to the web server.

13. The method of claim 11, wherein the security is achieved by using an encryption manner.

14. The method of claim 11, wherein the web server using a secure socket layer (SSL) for security.

15. The method of claim 11, wherein the method is used in collaborative sessions through the network in e-conference, e-training or e-learning.

16. The method of claim 11, wherein the shared file is displayed by a web browser or a custom program.

17. The method of claim 11, wherein only can the meeting host share the shared file with the attendees.

18. The method claim 11, further comprising changing the host by another one of the attendees to control and modify the shared file.

19. A system of using at least one shared data file for data collaboration for a plurality attendees in a meeting, the system comprising:
a web server;
a plurality local displaying devices respectively used by the attendees, for displaying any possible file;
a network, wherein the attendees can send a shared file to the web server through the network, wherein the shared file can be displayed at the local displaying devices for the attendees,
wherein the shared file is shared by the attendees for handling and modification.

20. The system of claim 19, wherein an encryption is used for transferring the shared file to the web server.

21. A system of using at least one shared data file for data collaboration for a plurality attendees in a meeting, the system comprising:
a web server, solely controlled by one of the attendees, serving as a meeting host;
a plurality local displaying devices respectively used by the attendees, for displaying any possible local file;
a network, wherein the attendees can send the local file as a shared file to the web server through the network, wherein the shared file is displayed at the meeting host and the attendees,
wherein the shared file is solely shared by the meeting host for handling and modifying and the attendee can see a change of the shared file.

22. The system of claim 21, wherein the meeting host can be changed to another one of the attendees by taking a control to the web server.
